(19) United States
(12) Patent Application Publication
(10) Pub. No.: US 2015/0198560 A1
(43) Pub. Date: Jul. 16, 2015

(54) ELECTROPHORETIC ANALYZER BY ELECTROMAGNETIC INDUCTION

(71) Applicants: José Félix MANFREDI, Jundiaí, São Paulo (BR); Marcelo TEIXEIRA DUARTE, Campinas, São Paulo (BR)

(72) Inventors: José Félix Manfredi, Jundiai (BR); Marcelo Teixeira Duarte, Campinas (BR); Karel Negrin Nåpoles, Campinas (BR)

(21) Appl. No.: 14/423,315

(22) PCT Filed: Aug. 26, 2013
(86) PCT No.: PCT/BR2013/000329

§ 371 Date: Feb. 23, 2015

(30) Foreign Application Priority Data
Aug. 29, 2012 (BR) 10 2012 021974 3

(51) Int. Cl. G01N 27/447

(52) U.S. Cl. CPC G01N 27/44786

(57) ABSTRACT

Electrophoretic analyzer by electromagnetic induction, comprising a ferromagnetic toroidal core (1), which is coupled to an electrical winding inductor (2), along which circulates an alternating input current that induces formation of a variable magnetic flux confined in the core, that generates alternating electric current induced in the support (3), forcing the migration of electrically charged molecules, components of the test sample. An injector (4), mounted at one end of the holder, allows the introduction of the sample, while a detector (5), located at the opposite end, monitors the passage of discrete components and sends an electronic signal to a microcomputer, which processes the data and display it to the operator. The introduction of a fast electrical switch (6), as a diode, by connecting the ends of the support, enables opening and closing of the secondary circuit at the same frequency of the alternating current of the inductor, resulting in particle movement in one direction and its consequent separation by differential migration.

### TECHNICAL FIELD AND APPLICABILITY OF THE INVENTION

The instrument herein described is proposed for application in chemical analysis involving separation techniques such as in electrophoresis.

### BACKGROUND OF THE INVENTION

The systems presently in use for electrophoresis analysis utilize polarized electrodes to perform charged species separation. Considering influential factors in electrophoretic migration, macromolecules with different sizes and/or charges, in solution, subjected to an electric field, migrate at different rates, depending on their sizes and charges, to oppositely charged pole. After a while, the molecules will migrate differentially, separating from the original mass, featuring the electrophoresis technique as an analytical tool for separation of complex mixtures, with applications in biotechnology research and development, industrial control, clinical diagnostics and forensics.

This application concerns to an electrophoretic analyzer implementing the innovative concept of electric field generation by electromagnetic induction over the entire length of support, and combines traditional advantages of the technique to innovative features of an instrument that can be used without operational restrictions found in equipment based on polarization through electrodes.

A property of electrically charged species in a solution is to migrate due to action of an applied electric field. The analytical technique of separation of components of a complex sample, based on their differential migration in electromagnetic field, is called Electrophoresis, and occupies a prominent place among modern methods of analysis, due to its applicability to biochemical samples, such as DNA, associated with the genome and in vitro diagnosis.

Electrophoresis is not commonly carried out in liquid solutions, subjected to physical influences from environment, such as mechanical disturbances due to fluid convective motions (the applied potential difference generates heat in conductive medium), which would make the process less reproductive. Systems have been developed in which such disturbances are minimized, using rigid matrices (paper or gel medium) which interacts with solution and reduces mechanical interference and spurious movements of convection. The hydrophilic nature of cellulose provokes formation of water surface film over paper, less sensitive to external influences. In case of gel, usually agarose or polyacrylamide, the solution becomes occluded in polymer pores, being protected against mechanical interference and convection.

Mechanical and thermal factors are not the only ones that significantly affect the migration of charges in solution. The processes responsible for mass transportation are migration, diffusion and convection. Migration speed of carrier molecules is crucial and is determined by applied electric field intensity (higher applied voltages imply faster charges migration over the pole of opposite sign), total charge of analyte particles (higher charges provoke greater electrostatic attraction between them and pole of opposite sign) and molecular size (larger carrier particles have lower migration speed due to frictional interactions between molecule, solvent, support and other ions in solution).

Conduction of continuous electric current in ionic medium occurs by oxidation at anode, and reduction at cathode, both electron transfer reactions, which depend on the nature and concentration of electroactive species and nature and potential of electrodes. When electrical potential is applied to an electrode in ionic solution, the current flow originates excess (or deficiency) of negative charge along its surface, attracting oppositely charged ions from surrounding solution to form a bilayer. The first layer is compact and potential decreases linearly across it. Potential decreases exponentially through subsequent layer, more diffuse [1].

Considering Electrophoresis on paper, macromolecule's friction with support is small and particle size does not significantly affect its migration speed. Separation takes place based on particle's charge. This kind of Electrophoresis is useful for separation of proteins which, due to their diverse amino acid composition, have great differences in total charge. Paper is not a suitable support for separation of nucleic acids, as they have a charge/molar mass relation almost constant, regardless of size or nucleotides sequence, and have the same electrostatic attraction by positive pole. Paper has little ability to separate molecules based on molecular size and different nucleic acid fragments are not efficiently separated in this medium, and a gel medium should be used, with solution distributed in small cavities, which implies a strong macromolecule friction with medium and promotes separation based on molecular size. It is practically the only type of medium used for separation of nucleic acid fragments.

As further development of technique, arises Capillary Electrophoresis [2], which uses a capillary tube of fused silica filled with electrolyte solution, with ends immersed in same content reservoirs, each one with an inert electrode, usually platinum, polarized with high voltage (typically from 10 to 30 thousand volts). Devices for sample injection and detection are installed at the ends of capillary tube. This mode has higher efficiency and greater power of resolution, requires small sample volumes (1-10 nL) and provides results in less time. Sample components are separated based on difference of ionic mobility, related to the charge/mass ratio and structural properties. Ion mobility is given by:

$${μ}_{1} = \frac{{L}_{d} {L}_{c}}{V {t}_{i}} - {μ}_{o} = \frac{{λ}_{e}}{F}$$

$${v}_{i} = {μ}_{i} \frac{v}{{L}_{c}}$$

$${v}_{a} = ( {μ}_{1} + {μ}_{o} ) \frac{v}{{L}_{c}}$$

$${v}_{o} = {μ}_{o} \frac{v}{{L}_{c}}$$

where μᵢ is specie's ion mobility (determined by charge/hydrated radius rate), μₒ is the mobility of the electroosmotic flow (factor that depends on properties such as dielectric constant and fluid's viscosity), L_{d} is the distance from injection point to detection point, L_{c} is capillary's length, V is the potential difference applied, λₑ is specie's equivalent conductance, F is Faraday's constant, vᵢ is the ion velocity and vₐ the apparent speed.

Technique's versatility derives from its different operating modes, each one with its own separation mechanism, which makes possible to obtain additional and orthogonal information. It is a fast and accurate analytical technique that requires small amounts of sample and reagents and can be used for separation of analyte mixtures of different molecular sizes and hydrophobicities. Prevalent operation methods [3] are open tube or free zone, micellar electrokinetic capillary chromatography, gel electrophoresis, isoelectric focusing, and isotachophoresis. These operating modes can be used simply by changing buffer constituents, which offers an operational advantage over traditional chromatography techniques, which require changing phases and greater care in sample preparation and injection. Small sample quantity and ease of use, combined with structural information, make Electrophoresis the most important analytical technique in Biochemistry [4].

Finest capillaries allow better dissipation of heat generated by Joule effect and better resolution of species, because temperature increase causes expansion of band migration, breakdown of sensitive samples and boiling of the electrolytic solution. Higher potential differences accelerate the analysis and allow better resolution. Detection techniques commonly used in capillary electrophoresis are: UV-vis absorbance (predominant technique), fluorescence, amperometry and mass spectrometry.

A complete description of such equipment can be found in the literature on electrophoresis. We suggest the book “Electrophoresis in Practice”, R. Westermeier, 4^{th} edition, Wiley-VCH, Weinheim, 2005.

### General Specification of the Invention

Creation of electric field by electrode polarization brings a strong disadvantage, which is the lack of field uniformity, comprising intensity and direction of power lines along the support. FIG. 1 shows such lines in an electrophoretic tank, whose real behavior is far away from idealized constant field. As a result, migration of components depends, in practice, not only on structural characteristics of charged particles and their physicochemical interactions with the medium, but also on its geometrical position in the medium, which generates interference in the analytical procedure.

Polarization of electrodes causes a second drawback, which is formation of ionic layers of solution on electrodes surfaces, by accumulation of opposite charges, that causes electrostatic shielding. This effect decreases resulting field and its perception by sample charged molecules is weaker than theoretical. Current instruments use rectifiers and voltage lifts, expensive and bulky, in addition to natural disadvantages arising from the presence of a high voltage source on the bench and from heat generation along the support. Species submitted to electrophoresis are typically biological, sensitive to heat.

The magnetic induction is quantitatively described by Faradays law [5]:

$$ɛ = ∮ \vec{E} \cdot d \vec{1} = - \frac{d {ϕ}_{m}}{d t}$$

εis the induced voltage.
\vec{E} is the electric field.
l is the linear extension of the propagating media.
t is time.
φₘ is the magnetic flux.

Voltages and currents generated by variable magnetic fields are called induced, and the phenomenon is known as magnetic induction. A variable magnetic field may be produced by a variable current in a coupled circuit, which can start an induced current.

The proposed instrument operates from a ferromagnetic toroidal core that works as the magnetic flux spreader, coupled with two circuits, in analogue concept to the voltage transformers. The AC (50-60 Hz) input in a primary winding produces a varying magnetic flux contained in the toroid. The electrophoretic support, arranged as secondary circuit, presents an induced current, which includes medium ions (buffer and sample), migrating due to their charge, ion mobility and electroosmotic flow.

As the induced current is alternated, the ions would tend to vibrate, without resulting displacement. If the ends of the support are connected to a solid state switch, such as a high voltage diode, current will flow only in diode's driving direction, acting as open circuit in the opposite direction. With the closed circuit through the diode, the magnetic flux variation creates an effective induced current along support and ionic species move. Although there is sudden magnetic flux variation when key opens, mechanical inertia of charged particles, due to their finite and non-negligible mass, prevents its rollback to the equilibrium position. As a result, migration of particles occurs in one direction due to induced current in the closed circuit, featuring the electrophoretic process. It should be emphasized that the device proposed here is an analyzer and applies to the separation of chemical species, and should not be mistaken with detectors [6] or reactors [7] based on similar construction concept.

The proposed concept eliminates the need for current rectifier and high voltage generators, significantly reducing the physical dimensions of the instrument and its initial and maintenance costs. The magnetic field, confined to the core, does not propagate electromagnetic interference (from the primary coil) to the environment. The mechanical decoupling between support and core prevents heat transfer (estimated at 2% of input energy) and its consequences on sample.

### DESCRIPTION OF THE DRAWINGS

FIG. 1 illustrates the field lines generated by two polarized electrodes; and FIG. 2 shows a preferred embodiment of the Electrophoretic Analyzer by Electromagnetic Induction, with the main elements that compose it.

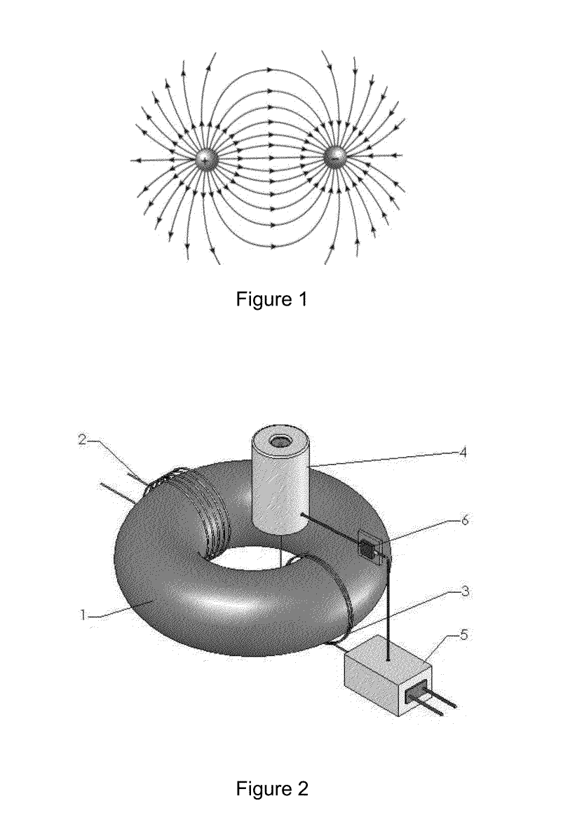

According to the illustrations, the Electrophoretic Analyzer by Electromagnetic Induction is composed of a toroidal core (1), an inducer winding (2), an electrophoretic support with conductive medium (3), an injector (4), a detector (5), and a quick switch, typically a diode (6), monitored by a microcomputer, not shown.

### Construction of the Instrument

The core is made of ferromagnetic metal alloy. The induction winding is made of a good electrical conductor wire, like copper or aluminum. The electrophoretic medium may be a capillary tube of inert material, like quartz, filled with gel or buffer solution, or a fiat flexible ribbon of inert plastic, recovered of gel, or buffer wetted paper. Injector and detector may be anyone of many already available commercially and will be incorporated into the instrument as required. Switch is a fast diode. Electronic control of the whole system is carried out using a microcomputer, FDA or tablet. Results are displayed in an external device, not shown in the drawing, that can be a screen or a printer/plotter recorder.

### Applications

The instrument can be used in any determination which involves separation and qualitative or quantitative, analysis of charged chemical species in a eletrically conductive medium, either in a laboratory environment or directly coupled to a process line.

Electrophoresis allows development of qualitative and quantitative analysis of amino acids, proteins, peptides, carbohydrates, metal ions, enantiomers, aromatic hydrocarbons, nucleotides, pesticides, organic acids and vitamins, among other species of laboratory interest, and is extensively used for analysis of biochemical and pharmaceutical components, industrial effluents and waste water (environmental analysis), and quality control of food and chemicals.

Among the many applications of electrophoresis it is analysis of metal cations. Since they present similar values of equivalent conductance, complexing agents are used, which alter values of mobility of one or more cations in the sample. If two ions have the same size, the one with higher charge will have higher speed, while smaller ions migrate faster than larger ions of same charge.

### References

1. J. O'M. Bockris, M. A. V Devanthan, and K. Mueller, Proc. Roy. Soc, Ser. A. 274, 55 (1963).

2. Schmitt-Kopplin, P. (ed.), Capillary electrophoresis: methods and protocols, New York: Humana Press, 2^{nd} ed., 2008.

3. Wilson, K., Walker, J. Principles and techniques of biochemistry and molecular biology. Cambridge University Press. New York. 2010. Ch. 10.

4. Altria, K. D., J. Chromatog. A., 1999, 856, 443.

5. Tipler, P. A., Mosca, G. P. Physics for scientists and engineers. New York: W. H. Freeman. (2003)

6. CN 101957341 A (UNIV. SUN YAT SEN) 2011-01-26

7. U.S.20090197773 A1 (ONTO YASUNORI [JP]) 2009-08-06

What is claimed is:

1. Charged species separation system, particularly applicable to electrophoresis, comprising:
a electromagnetic field propagator core (1) which concentrates the field lines generated by
a primary winding (2), through which an alternate current is circulating, and leads through a conductive medium deposited on
a backing element (3), where is generated an induced current;
an injection device to introduce sample components (4), with are particles electrically charged that move on in consequence of the induced field;
a detection device (5), which generates an electrical signal to be electronically processed;
a rapid rectifier switch (6) coupled to the ends of said backing element.

2. System according to claim 1, wherein said backing element is an electrophoretic medium, which comprises the analytical separation medium, wherein induced current occurs.

3. System according to claim 1, wherein said fast switch is a rectifying diode, capable of opening and closing the circuit at the frequency of the input current in the winding inductor.

4. System according to claim 1, wherein said backing element is an inert capillary tube filled with a conducting gel or buffer solution.

5. System according to claim 1, wherein said backing element is an inert flexible ribbon recovered with a conductive gel.

6. System according to claim 1, wherein said backing element is a chemically activated surface porous ribbon wetted with buffer solution.
